(19) United States
(12) Patent Application Publication
(10) Pub. No.: US 2025/0259445 A1
(43) Pub. Date: Aug. 14, 2025

(54) Systems and Methods of Image Data Curation

(71) Applicant: Vivint LLC, Provo, UT (US)

(72) Inventor: Michelle Bea Zundel, Provo, UT (US)

(73) Assignee: Vivint LLC, Provo, UT (US)

(21) Appl. No.: 19/053,523

(22) Filed: Feb. 14, 2025

Related U.S. Application Data
(60) Provisional application No. 63/553,524, filed on Feb. 14, 2024.

(51) Int. Cl. G06V 20/40; G06V 10/25; G06V 10/70; G06V 20/52

(52) U.S. Cl. CPC G06V 20/41; G06V 10/25; G06V 10/70; G06V 20/44; G06V 20/47; G06V 20/52

(57) ABSTRACT

Presented herein are system and methods for handling image data of home security and/or automation applications. Portions of image data (e.g., clips) can be tagged for later searching and/or presenting. A summary of events can be presented, according to tagged image data.

### CROSS REFERENCE

This application claims priority to U.S. Provisional Patent Application, 63/553,524, filed Feb. 14, 2024, and entitled SYSTEMS AND METHODS OF IMAGE DATA CURATION, which is incorporated by reference herein in its entirety.

### TECHNICAL FIELD

This application relates generally to handling of image data in home security and automation applications. In particular, the present application relates to tagging image data for searching and/or presenting portions of the image data (e.g., clips).

### BACKGROUND

Cameras are widely used to monitor premises for security reasons. However, camera footage captured by a camera but not viewed by a user cannot be used by the user, for example, to prevent harmful activities. As an example, a homeowner cannot practically constantly monitor their security camera feeds to identify and/or prevent package theft.

Home security and/or automations systems that include cameras for monitoring premises collect image data (e.g., still images, video footage). For example, video footage is stored for later viewing. However, the amount of video captured by a single camera for a single day makes review of the image data challenging, even at faster review speeds. The amount of video footage available for review is multiplied for every camera included in a system. Searching, filtering, or otherwise finding desired or relevant portions of video footage is challenging. The increased availability of video footage can, ironically, decrease a likelihood that the footage is actually reviewed.

Typically, much of the video footage collected is entirely irrelevant. For example, hours of video footage of an empty front porch as viewed from a doorbell camera provides no insight for a homeowner and is of relatively little value. Image data captured of a premises when all is normal and as anticipated simply need not be reviewed.

By contrast, video footage that may be of assistance or other interest to a homeowner is a relatively small percentage compared to all captured video footage. For example, when entities enter into areas within a field of view of a camera and take actions and initiate events that may be of interest to the homeowner, video footage of the entities and/or events may be of interest to a homeowner. An unfriendly entity may perpetrate an event, such as a burglary, solicitation, vandalization, or other undesirable event, while a friendly entity may be returning home, coming for a visit, bringing a gift, or other desirable events. Presently available systems and methods are limited in handling and/or presenting desired, interesting, or otherwise relevant image data in an easily or otherwise practically reviewable manner.

### SUMMARY

The present disclosure is directed to systems and methods for handling image data, for example to provide ability to search and/or filter image data collected by a security, automation, and/or other monitoring system of a premises, to enable presentation of a summary of events and/or entities at the premises.

### BRIEF DESCRIPTION OF THE DRAWINGS

The accompanying drawings constitute a part of this specification, illustrate an embodiment, and, together with the specification, explain the subject matter of the disclosure.

FIG. 1 illustrates a block diagram of a home security and/or automation system and an example system for handling image data, according to one embodiment of the present disclosure.

FIG. 2 illustrates a diagrammatic view of systems and methods of generating tagged image data, according to one embodiment of the present disclosure.

FIG. 3 is a flow diagram of a method of handling image data, according to one embodiment of the present disclosure.

FIG. 4 is an example user interface for presenting a summary of events, according to one embodiment of the present disclosure.

FIG. 5 is an example user interface presenting a summary of events, according to one embodiment of the present disclosure, based on a search query.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Disclosed herein are systems and methods for handling (e.g., curating) image data. Cameras are commonly used for monitoring, such as monitoring premises and/or a surrounding environment, such as for security or safety reasons. For example, home security and/or automations systems that include cameras capture and store video footage for later viewing. Such systems capture significant amounts of image data, which makes review of the image data challenging and even impractical with currently available systems. Homeowners do not want to watch a full day of video footage, even at faster playback speed, just to understand what is happening at the premises. Ironically, the more comprehensive the video footage, the likelihood that the footage is actually reviewed by a homeowner probably decreases.

Furthermore, searching, filtering, or otherwise finding desired or relevant portions of video footage is challenging. For example, if a vandal strikes on the premises during the workday, locating the video footage for the time of the vandalism can be onerous as searching based on characteristics or attributes of events is not possible with presently available systems. Video footage that may be of assistance or other interest to a homeowner is a relatively small percentage compared to all captured video footage and is difficult to locate in the massive amounts of video footage captured. For example, if homeowner finds dog poop on the front lawn three times in one week, and believes it is a neighbor's dog that is responsible, presently available systems and methods of handling image data offer no practical way to quickly search a full week of image data for only video clips relevant to dogs defecating on the premises. Presently available systems generally store video footage or clips captured in video footage in chronological order. Sorting and searching are limited, typically based on time. Reviewing hours of footage, endless clips, etc. in chronological order to locate “key” (e.g., relevant, of interest, meaningful) events or people is bewilderingly time consuming. As another example, if a mailbox is destroyed by vandals while all the residents of the premises are on vacation for a week, presently available systems and methods of handling image data do not enable the homeowner to provide a search query to quickly locate, within a full week of image data, any video clips involving a person approaching the mailbox (e.g., the mail delivery person or the vandal), or even more precisely an entity (e.g., human, animal, automobile) striking the mailbox. Presently available systems and methods are simply limited in handling and/or presenting desired, interesting, or otherwise relevant image data in an easily or otherwise practically reviewable manner.

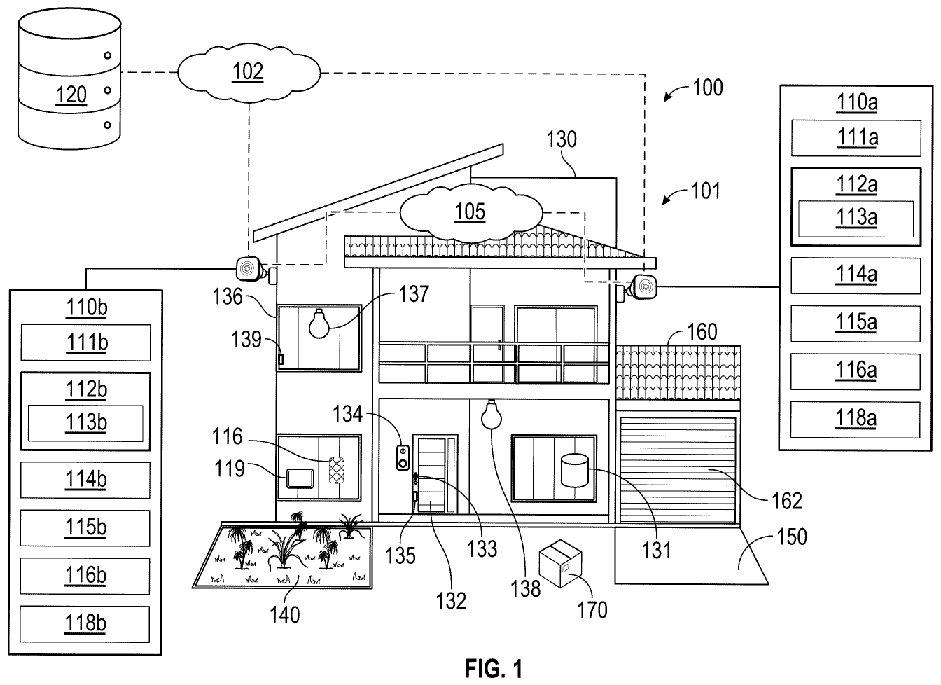

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

The building 130 may include a security system 101 or one or more security devices that are configured to detect and mitigate crime and property theft and damage by alerting a trespasser or intruder that their presence is known while optionally alerting a monitoring service about detecting a trespasser or intruder (e.g., burglar). The security system 101 may include a variety of hardware components and software modules or programs configured to monitor and protect the environment 100 and one or more buildings 130 located thereat. In an embodiment, the security system 101 may include one or more sensors (e.g., cameras, microphones, vibration sensors, pressure sensors, motion detectors, proximity sensors (e.g., door or window sensors), range sensors, etc.), lights, speakers, and optionally one or more controllers (e.g., hub) at the building 130 in which the security system 101 is installed. In an embodiment, the cameras, sensors, lights, speakers, and/or other devices may be smart by including one or more processors therewith to be able to process sensed information (e.g., images, sounds, motion, etc.) so that decisions may be made by the processor(s) as to whether the captured information is associated with a security risk or otherwise.

The sensor(s) of the security system 101 may be used to detect a presence of a trespasser or intruder of the environment (e.g., outside, inside, above, or below the environment) such that the sensor(s) may automatically send a communication to the controller(s). The communication may occur whether or not the security system 101 is armed, but if armed, the controller(s) may initiate a different action than if not armed. For example, if the security system 101 is not armed when an entity is detected, then the controller(s) may simply record that a detection of an entity occurred without sending a communication to a monitoring service or taking local action (e.g., outputting an alert or other alarm audio signal) and optionally notify a user via a mobile app or other communication method of the detection of the entity. If the security system 101 is armed when a detection of an entity is made, then the controller(s) may initiate a disarm countdown timer (e.g., 60 seconds) to enable a user to disarm the security system 101 via a controller, mobile app, or otherwise, and, in response to the security system 101 not being disarmed (or being accepted by a user prior to completion of the countdown timer), communicate a notification including detection information (e.g., image, sensor type, sensor location, etc.) to a monitoring service (optionally after giving a user a chance to disarm the security system 101), which may, in turn, notify public authorities, such as police, to dispatch a unit to the environment 100, initiate an alarm (e.g., output an audible signal) local to the environment 100, communicate a message to a user via a mobile app or other communication (e.g., text message), or otherwise.

In the event that the security system 101 is armed and detects a trespasser or intruder, then the security system 101 may be configured to generate and communicate a message to a monitoring service of the security system 101. The monitoring service may be a third-party monitoring service (i.e., a service that is not the provider of the security system 101). The message may include a number of parameters, such as location of the environment 100, type of sensor, location of the sensor, image(s) if received, and any other information received with the message. It should be understood that the message may utilize any communications protocol for communicating information from the security service to the monitoring service. The message and data contained therein may be used to populate a template on a user interface of the monitoring service such that an operator at the monitoring service may view the data to assess a situation. In an embodiment, a user of the security system 101 may be able to provide additional information that may also be populated on the user interface for an operator in determining whether to contact the authorities to initiate a dispatch. The monitoring service may utilize a standard procedure in response to receiving the message in communicating with a user of the security service and/or dispatching the authorities.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a depth sensor 114a (e.g., radar sensor 114a), a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same, but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect a breach of security event for which the respective sensors are configured. For example, the microphones 118 may be configured to sense sounds, such as voices, broken glass, door knocking, or otherwise, and an audio processing system may be configured to process the audio so as to determine whether the captured audio signals are indicative of a trespasser or potential intruder of the environment 100 or building 130. Each of the signals generated or captured by the different sensors may be processed so as to determine whether the sounds are indicative of a security risk or not, and the determination may be time and/or situation dependent. For example, responses to sounds made when the security system 101 is armed may be different to responses to sounds when the security system 101 is unarmed.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the security system 101 and/or security device may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 130. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the security system 101 and/or security devices may may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the security system 101 and/or one or more security devices may include one or more speakers 116 The speaker(s) 116 may be independent from other devices or integrated therein. For example, the camera(s) may include one or more speakers 116 (e.g., speakers 116a, 116b) that enable sound to be output therefrom. In an embodiment, a controller or other device may include a speaker from which sound (e.g., alarm sound, tones, verbal audio, and/or otherwise) may be output. The controller may be configured to cause audio sounds (e.g., verbal commands, dog barks, alarm sounds, etc.) to play and/or otherwise emit those audio sounds from the speaker(s) 116 located at the building 130. In an embodiment, one or more sounds may be output in response to detecting the presence of a human within an area. For example, the controller may cause the speaker 116 may play one or more sounds selected to deter a detected person from an area around a building 130, environment 100, and/or object. The speaker 116, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The security system 101, one or more security devices, and/or the speakers 116, in some implementations, may be configured to store and/or has access to a library comprising a plurality of different sounds and/or a set of dynamically generated sounds so that the controller 106 may vary the different sounds over time, thereby not using the same sound too often. In some embodiments, varying and/or layering sounds allows a deter sound to be more realistic and/or less predictable.

One or more of the sounds may be selected to give a perception of human presence in the environment 100 or building 130, a perception of a human talking over an electronic speaker 116 in real-time, or the like which may be effective at preventing crime and/or property damage. For example, a library and/or other set of sounds may include audio recordings and/or dynamically generated sounds of one or more, male and/or female voices saying different phrases, such as for example, a female saying “hello?,” a female and male together saying “can we help you?,” a male with a gruff voice saying, “get off my property” and then a female saying “what's going on?,” a female with a country accent saying “hello there,” a dog barking, a teenager saying “don't you know you're on camera?,” and/or a man shouting “hey!” or “hey you!,” or the like.

In some implementations, the security system 101 and/or the one or more security devices may dynamically generate one or more sounds (e.g., using machine learning and/or other artificial intelligence, or the like) with one or more attributes that vary from a previously played sound. For example, the security system, one or more security devices, and/or the speaker 116 may generate sounds with different verbal tones, verbal emotions, verbal emphases, verbal pitches, verbal cadences, verbal accents, or the like so that the sounds are said in different ways, even if they include some or all of the same words. In some embodiments, the security system 101, one or more security devices, the speaker 116 and/or a remote computer 125 may train machine learning on reactions of previously detected humans in other areas to different sounds and/or sound combinations (e.g., improving sound selection and/or generation over time).

The security system 101, one or more security devices, and/or the speaker 116 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The security system 101 and/or the one or more security devices, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the security system 101 and/or the one or more security devices may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, he security system 101 and/or the one or more security devices may play a primary sound layered and/or overlapping with one or more secondary, tertiary, and/or background sounds, varying the sounds and/or the combination from one or more previously played sounds and/or combinations, or the like.

The security system 101 and/or the one or more security devices the security system 101 and/or the one or more security devices, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The security system 101 and/or the one or more security devices, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the security system 101 and/or the one or more security devices may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the security system 101 and/or the one or more security devices may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101 and/or the one or more security devices are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g., stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

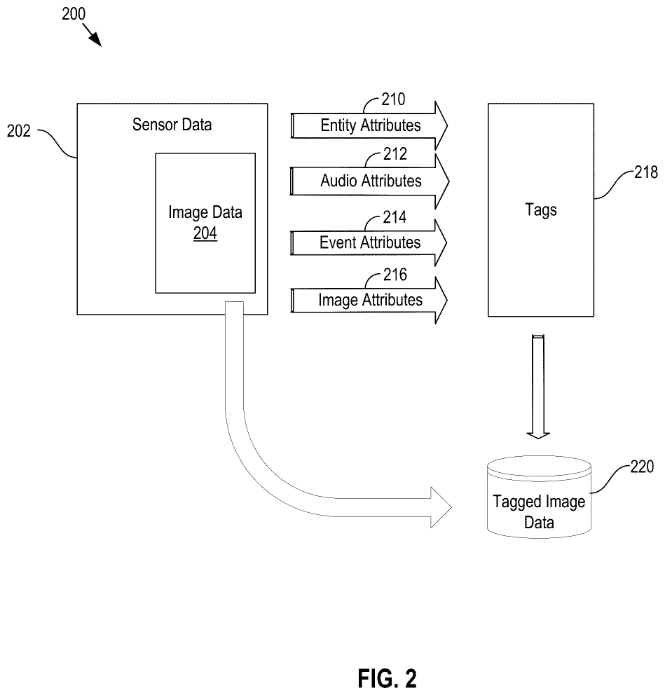

FIG. 2 depicts a diagram 200 of systems and methods of generating tagged image data, according to one embodiment of the present disclosure. Sensor data 202 is collected by one or more sensors of a home automation/security system. The sensor data 202 can include image data 204 of an environment of premises monitored by the home automation/security system. Attributes can be determined from the sensor data 202. From that sensor data 202, entities within an environment may be detected, and entity attributes 210 can be determined for each of the entities. In some embodiments, audio attributes 212 may also be determined from the sensor data 202. In some embodiment, event attributes 214 may be determined from the sensor. Image attributes 216 may also be determined or otherwise available. The attributes (e.g., entity attributes 210, audio attributes 212, event attributes 214, and/or image attributes 216) may be used in generating tags 218 that can be used in generating tagged image data 220.

The sensor data 202 can be data from one or more sensor devices. The sensor devices can include but are not limited to image sensors (e.g., cameras), audio sensors (e.g., microphones), depth sensors (e.g., radar sensors), light sensors, moisture sensors, and any other sensor device that can capture and provide sensor data that indicates information about an environment and/or be used to identify or otherwise detect an entity within the environment and/or an occurrence of an event within the environment.

An entity can be a person within the environment. In some cases, the entity can include multiple persons within the environment. The entity can be known or unknown to a homeowner, resident, or neighbor of a building. For example, the entity can include a mail delivery person, a stranger, a child, a friend, a gardener, or a group of these people or other people. The entity can include a homeowner, resident, or neighbor of a building (e.g., house, residence) of the environment. In some cases, the entity can be a friendly entity, such as the homeowner, a visitor, the mailman, a relative, among others. A friendly entity can be or include an entity which is welcome, invited, or to be received to a building of the environment, has business in or around the building of the environment, or otherwise has positive intentions for the building of the environment or its occupants. In some cases, the entity can be an unfriendly entity. An unfriendly entity can be or include an entity who is not welcome to the building of the environment or the surrounding areas, an entity who is to be deterred from the environment, or an otherwise undesirable entity. An entity can also be an animal, such as a pet, dog, cat, etc. An entity can also be an object within the environment, such as a vehicle, a bike, a tree, a mailbox, a decorative fixture, etc.

An event can be an action or occurrence in the environment. An event may generally involve an entity. For example, a vandal inflicting damage on the premises, a thief approaching, a car speeding past, etc. In less common circumstances, an event may occur apart from any entity, or without involvement of any identifiable entity. For example, a watering by an automated irrigation system (e.g., sprinklers) on the premises, water flowing out of the ground, a shattering of glass not visible in image data, etc.

A system according to some embodiments of the present disclosure can utilize the one or more sensors or sensor data gathered therefrom to detect one or more entities within the environment. In some embodiments, a machine-learning model may be trained and utilized to detect or otherwise identify the one or more entities.

Once an entity is identified, entity attributes 210 of an entity may be determined. A system according to some embodiments can determine characteristics of an entity, which may be entity attributes, and which may be used to determine other attributes. Entity attributes may include a distance attribute, such as a distance from another entity, a distance from a reference, a distance from an image capture device, or the like. Entity attributes may include a directionality attribute indicating a direction of travel, path, or the like, of the entity. Some entity attributes of an entity may be determined according to at least one of physical characteristics of the entity or behavioral characteristics of the entity. In some cases, the system can determine from image data, or other sensor data from the sensors of the environment, characteristics of the entity that correspond to a person.

Determining the one or more characteristics of the person may include determining clothing, height, girth, weight, hair color, gait, category, profession, identity, carried objects, a classification, a sub-classification, and other characteristics. The characteristics may be determined using a machine learning model. The machine learning model can be trained using historical data and/or user input to identify characteristics in image data that can be defined or otherwise determined as entity attributes. In an example, a camera executing a machine learning model may determine that a person is wearing jeans and a red t-shirt. In an example, a camera executing a machine-learning model may determine that a person is a mail carrier. In an example, a camera executing a machine-learning model may determine that a person is a child. In an example, a camera executing a machine-learning model may determine that a person is going door-to-door to sell something. In an example, a camera executing a machine-learning model may determine that a person is jogging. In an example, a camera executing a machine-learning model may determine that a person is looking at a package on a porch. The characteristics determined may include the detected person making noises such as shouting, whispering, stomping, or speech. The characteristics may include the person engaging with a part of the building, such as the door, the e-lock, or the exterior light, among others.

Physical characteristics may correspond to an entity a shape of the entity (e.g., a bounding box), a size of the entity, a sound of the entity (e.g., a vocal pitch or tone), among others. Behavioral characteristics of the entity can include movements of the entity (e.g., a gait or gesticulation), a sound of the entity (e.g., a cadence of speech or a selection of words spoken), or other such behavioral characteristics described herein.

A positioning of an entity within the environment and/or a distance of an entity relative to another entity can be a characteristic of the entity. For example, a distance of a person from an object such as a vehicle can be a characteristic of the entity. A direction of travel of an entity can be a characteristic of an entity. A speed of travel of an entity can be a characteristic of the entity. A path of travel of an entity can be a characteristic of an entity, and those characteristics of an entity can be entity attributes 210.

In some cases, characteristics of an accessory of an entity can be determined from the sensor data and can be entity attributes. Accessories of an entity can include an object carried by the entity, clothing worn by the entity, jewelry, among others.

In some embodiments, a machine learning model may be trained and utilized to determine or otherwise identify additional entity attributes, in accordance with characteristics of the entity. These additional attributes may correspond to an intent of an entity. The machine-learning model may be trained by applying the machine-learning model on historical sensor data including image data of various objects and entities. In an example, a burglar may be identified, using a machine-learning model, on a porch of a house. In an example, a homeowner may be identified, using a machine learning model executed on a camera, approaching a porch of the house via a walkway. Determining the attributes of an entity may include tracking movement of the entity. In an example, a “burglar” attribute of an entity (e.g., an unfriendly entity) may be determined at least in part, using a machine-learning model, by tracking the movement of the entity across a lawn of the house to a window of the house. In an example, a “neighbor” attribute of a friendly entity may be determined at least in part, using a machine learning model, by tracking the movement of the entity down a walkway towards a porch of the house. The entity may be identified by the machine learning model as an entity type, such as friendly or unfriendly, based on the movement of the entity within the environment. For example, an entity may be identified as an unfriendly entity based on movements performed by the entity which matches the attributes of a burglar, such as pacing in place, crouching, shaking a door, or checking over his shoulder.

In some embodiments, audio attributes 212 may also be determined. One or more sensors of a system may include one or more microphones to capture audio data of an environment. The audio data may include sounds made or caused by an entity of the one or more entities. In an example, a loud crash resulting from an entity swinging a baseball bat to strike a mailbox on the premises is a sound that can be associated with the entity. Similarly, a hushed celebratory remark that “The [car] doors are unlocked!” can be associated with an entity. In another example, the sounds of an engine and/or brakes of a delivery truck pulling up at the premises can be associated with both the truck as an entity and also associated with the driver entity that is delivering a package. By contrast, is an example a shattering of glass may be audible and captured as audio data without any entity associated—e.g., a vandal may shatter a window out of the field of view of any camera such that no entity is detected, identified, or otherwise able to be associated with the shattering glass sound. The audio data can be used to determine the audio attributes 212. In an example, a machine learning model can be used to determine the audio attribute 212. The machine learning model can be trained using historical data and/or user input to identify sounds in sound data that can be defined or otherwise determined as audio attributes.

A system according to some embodiments of the present disclosure can utilize the one or more sensors or sensor data gathered therefrom to detect or otherwise identify one or more events occurring within the environment. In some embodiments, a machine-learning model may be trained and utilized to detect or otherwise identify the one or more events. In an example, a theft event may be identified based on a detected entity obtaining an object (e.g., package, bicycle) on the premises of an environment and proceeding to remove the object from the premises. A detected entity (e.g., an unknown person) may be detected as approaching the premises and later be detected as leaving the premises with a new object entity that was not previously present when the entity was first detected and approaching the premises. In another example, a trespassing event may be identified based on an unknown entity entering the premises. In another example, a delivery event may be identified according to an entity entering the premises with an object entity (e.g., a package, flowers) and then departing the premises without the object entity. In another example, a vandalism entity may be identified according to a detected entity inciting a change to the premises (e.g., striking an object entity (mailbox, vehicle window), changing a surface (e.g., paint, toilet paper) of an object entity, etc.). In another example, a speeding event may be identified according to a detected entity (e.g., an automobile, truck, motorcycle) moving at a high velocity.

Once an event is identified, event attributes 214 may be determined, using sensor data captured by the one or more sensor devices. A system according to some embodiments can determine characteristics of an event, which may be event attributes, and which may be used to determine other attributes. A category or type of event may be determined and may be an event attribute. In an example, “theft” may be a category of event and an event may be determined to have a “theft” event attribute. In an example, “delivery” may be a category of event and an event may be determined to have a “delivery” event attribute. In an example, “demand response” may be a category of event and an event may be determined to have a “demand response” event attribute. The event attributes can be general or can be specific. A subcategory or subtype of event may be determined and may be an event attribute. For example, “package theft” may be an event attribute and may be a subcategory of a “theft” event attribute for an event that is a theft of a package and “bicycle theft” may be an event attribute and may be a subcategory of a “theft” event attribute for an event that is a theft of a bicycle. Event attributes can include timing data, such as time of day (e.g., sunrise, morning, afternoon, evening, sunset, dusk, night, hour: minute: second, etc.) the event occurred, season the event occurred, duration of the event. Event attributes can include weather (e.g., rainy, sunny, overcast, snow) and other environmental factors (e.g., smokey, dusty, solar radiation, solar radiance, solar irradiance, solar insolation, wind speed, temperature, humidity, and the like). Event attributes can include geolocation. Event attributes can include power levels (e.g., production of solar panels (or photovoltaic (PV) cells, production of a generator; battery or other storage discharge, reading at an inverter), load levels (e.g., air conditioning unit turns on, charging an electric vehicle), demand response characteristics (e.g., storage discharge), and other attributes pertaining to an electrical system (or state thereof) at the premises and coupled to or otherwise accessible to the system.

In some embodiments, some events can also be considered an outcome. An outcome attribute may be correlated with an intent attribute to indicate when a determined intent was in fact carried out. In an example, an entity may be detected and determined to have an entity attribute of thief and an entity attribute of an “intent to steal”. If the entity is detected as involved in a theft event the “theft” event attribute can correlate to the “intent to steal.” The correlations between intent entity attributes and outcome event attributes can be used for updating a machine learning model that may be used to determine intent of an entity.

Image attributes 216 may also be determined or otherwise available. Image attributes may be obtained from an image capture device and may pertain to field of view orientation, image, image capture device resolution, time data (e.g., time of day, date, clip duration), image capture device model, image capture device serial number, and other attributes that may be readily available with the image capture device, without need for a determination, such as by a machine-learning model. In some embodiments, a machine-learning model may be utilized to determine image attributes.

The attributes that are determined (including but not limited to entity attributes 210, audio attributes 212, event attributes 214, and image attributes, 216) may be used in generating tags 218. A tag may be a data structure that can be embedded with or in image data 204 to enable complex and/or advanced forms of finding relevant portions of image data (e.g., clips) and/or filtering image data to locate desired portions of image data (e.g., clips). The image data 204 (which may be a portion of the sensor data 202) is to be tagged using the generated tags 218 to enable searching for relevant clips or filtering to locate desired clips, according to search criteria or a search query. A tag may be part of a set of tags, each comprising individual data structures. A tag may be part of a set of tags collectively comprising one or more data structure, each data structure comprising one or more tags. A tag may be generated to include a reference to a portion of image data. A tag may be generated to be stored with a portion of image data. A tag may otherwise be associated with a portion of image data. Identifying a tag thereby identifies an associated portion of image data.

In some embodiments, the attributes are the tags. In some embodiments, the attributes are converted to tags 218. In some embodiments, the attributes are used to generate tags that correspond to the attributes. In some embodiments, the tags 218 are generated live time (or near live) as the sensor data (e.g., image data) is captured by the one or more sensors (e.g., the image capture device). In some embodiments, the tags 218 are generated in real-time. In some embodiments, the sensor data is collected and stored and at a later time the sensor data is processed to determine the attributes and/or the tags 218. In some embodiments, some attributes and/or some tags 218 are determined live or near live while other attributes and/or tags 218 are determined at a later time (e.g., with post-processing of the sensor data).

In an example, as sensor data 208 is captured a portion of image data 204 (“a clip”) is also captured and attributes are determined. One or more entities may be detected within an environment and entity attributes may be determined. A detected entity may be determined to have entity attributes of: unknown person, black clothes, black pants, mask, carrying a crowbar, a trespasser, a thief, with intent to break into a vehicle. These entity attributes may be used to generate tags 218 for the clip. Audio attributes may also be determined, such as: loud sound, impact, shattering class. An event, namely a vehicle break-in event, may be detected and event attributes may be determined such as vehicle break-in, shattered window, theft. Image attributes may be obtained including: 2:00 am time of day, date, 3-minute clip duration. These attributes may be utilized to generate tags 218 that can be stored in, with, or in association with the clip.

The image data 204 in combination with the tags 218 are used to generate tagged image data 220. The tagged image data 220 includes a set of tags each associated with a portion of the image data (e.g., clip). The set of tags includes one or more entity tags each indicating an entity attribute of one or more entities appearing in the portion of the image data. The tagged image data 220 is generated to be searchable on one or more designated tags 218, as specified by a search query and/or search term(s) to locate portions of the image data corresponding to the designated tags 218. A search query can be provided by a user and can be received. The search query can include one or more search terms. Relevant portions of the image data, or clips, can be located within the tagged image data. The clip(s) correspond to the one or more designated tags as indicated by the one or more search terms. The clip(s) that correspond to the designated tags can be provided for presentation on a display device to a user.

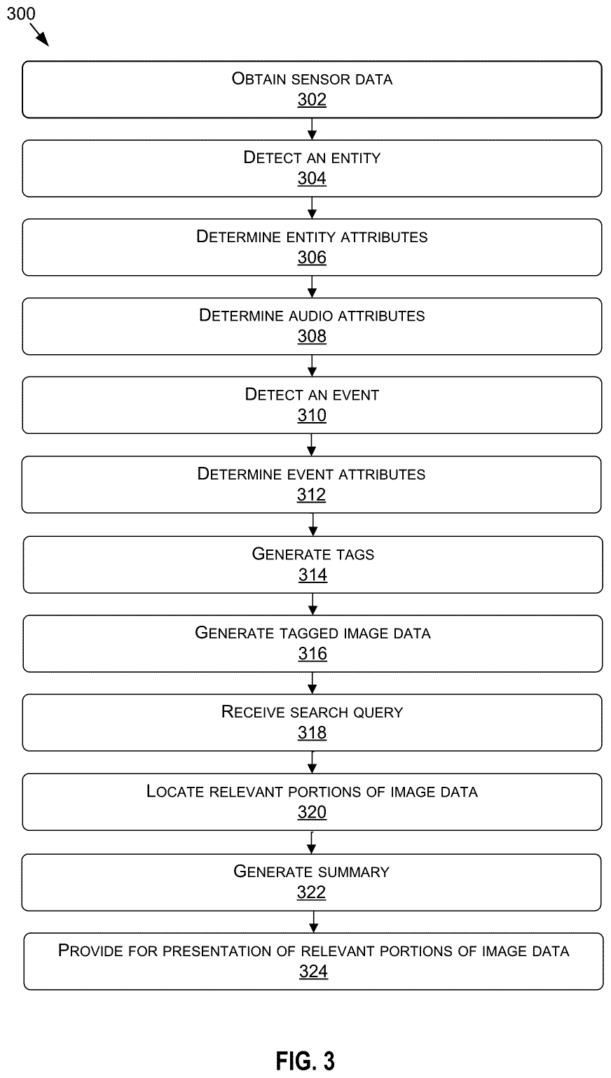

FIG. 3 is a flow diagram of a method 300 of handling image data, according to one embodiment of the present disclosure. Sensor data is obtained 302 from one or more sensors. The one or more sensors include one or more image capture devices (e.g., camera). One or more entities are detected 304 within an environment, according to the sensor data. The detection 304 of entities may include utilizing a machine learning model. Characteristics and/or entity attributes of the one or more entities are determined 306. The determining 306 of entity attributes may include utilizing a machine learning model.

Audio attributes can also be determined 308, such as using audio analytics and/or a machine learning model. The audio attributes may correspond to a detected entity, or may simply correlate to a portion of image data (e.g., a clip).

One or more events may be detected 310. Events may be associated with entities. The detecting 310 of an event may include utilizing a machine learning model. Once detected, event attributes may be determined 312. The event attributes may be determined 312 using a machine learning model.

The attributes can be utilized to generate 314 tags. The attributes utilized can include the entity attributes, the audio attributes, event attributes, image attributes, and any other appropriate attribute that can be determined. In some embodiments, the attributes can be or can become the tags and determining the attributes can be generating 314 the tags.

Image data captured by the one or more image capture devices and the tags can be utilized to generate 316 tagged image data. The generation 316 of the tagged image data can be live or substantially live time with capture of the image data, or can occur through post processing of the sensor data (including the image data) and/or later determination of attributes and/or generation of tags. The tagged image data is generated 316 in a manner to provide advanced find (e.g., searching) and filter (e.g., selection) of desired clips of image data (e.g., video clips).

A user can provide search terms or a search query, which is received 318 for searching and/or filtering the tagged image data. Nonlimiting examples of search queries providing search terms to filter clips based on tagged attributes are: “got near my bike,” “loitered too long,” “repeat appearances near my property,” “stepped on my lawn,” and “approached my car or mailbox.” Natural language processing can process a search query to determine search terms. For example, text input or spoken input may be converted to text and provided to a large language model to generate search terms and/or a search query that is received 318 by the method 300. The search terms/query received 318 can be matched to tags of the tagged image data.

Portions of the image data (e.g., clips) that correspond to (e.g., are relevant to) matching tags can be located 320 for presentation to the user. In an example, the results of a search based on the search terms/query can be presented in a chronological order. In an example, the results of the search can be presented in order of a relevance score or ranking.

In some embodiments, locating 320 relevant portions of image data can include identifying individuals and/or events that may be meaningful. As described, a search query and search terms therein can provide an indication of what individuals and/or events may be meaningful. In other embodiments, a set of one or more default search queries may provide indication of a default of meaningful. The set of one or more default search queries may evolve, such as by user configuration, updating machine learning models, etc. Examples of meaningful events may include, but are not limited to an unfamiliar person approaching an entity (e.g., bicycle, small child, pet, etc.) on the premises, an individual loitering too long (according to a threshold), a repeated appearance of an unfamiliar individual, appearance of an animal (e.g., a pet, a wild animal), and the like.

A summary can be generated 322 that includes relevant portions of the image data (e.g., clips), as selected, filtered, or otherwise located 320 according to the search query/terms. The summary can provide ready insight to those relevant portions of image data (e.g., clips). The summary can be provided 324 for presentation of relevant portions of image data. Providing 324 the summary for a user can save the user significant time to gain basic understanding of who came to/on the premises and what happened at/on the premises during a period of time. For example, the summary can be generated 322 to communicate “key” moments or otherwise relevant or interesting clips of events and/or entities captured throughout the day. The summary can convey the people and events that may be meaningful to a user. In some embodiments, the summary can be formatted as a default format, to present summarized information understood to be of potential relevance and/or interest to a user. In some embodiments, the summary format can be configurable, such as by user input, a user-defined template, or the like. In some embodiments, the summary format is configured according to the search terms/query.

Potential formatting of the summary that is generated 322 can include, but is not limited to thumbnail representations, labels, descriptions, generated commentary, a timeline, a single representation of multiple clips collapsed to represent a single or common instance or event (e.g., the landscaping crew captured numerous times during a 90 minute timeframe that the landscaping work was performed).

Examples of a summary that can be generated may include, but are not limited to:

A summary of all events and entities occurring within a distance D (e.g., five feet) of an area or zone of the property (e.g., an area where children play, a fenced area, a playground) during a period of time (e.g., 2-3 hour playtime, a day, a week, a month). Such a summary can effectively convey key moments that may indicate a potential harm to a user's children that may have occurred and/or that may occur (again) in the future, such as a potential predatory individual.

A summary of appearances of unidentified individuals during a period of time, which may effectively communicate to a user whether a potential burglar is casing the property.

A summary of appearances of an identified individual, which may effectively communicate to a user a potential stalker, a violation of a restraining order, or the like.

A summary of speeding cars the drove past the property, which may be provided as evidence to the city or local government that a stop sign or speed bumps need to be installed.

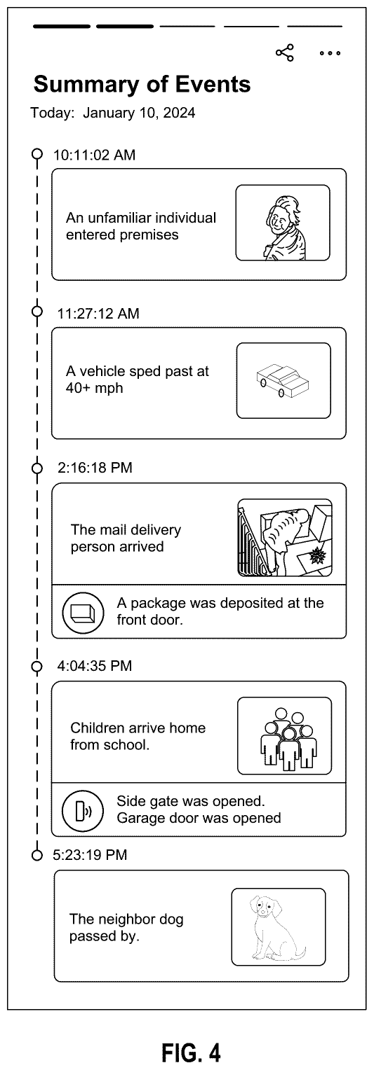

FIG. 4 is an example user interface for presenting a summary of events, according to one embodiment of the present disclosure. In FIG. 4, multiple events are captured and presented in a summary for simple review. For example, an unfamiliar individual entered the premises, a vehicle sped past at 40+ miles per hour, the mail delivery person delivered the mail and left a package, children arrived home from school, and a neighbor's dog passed by. The summary of events presents all the events of the period in a scrollable interface, with a thumbnail representing each event. The thumbnail can be clicked/tapped to activate playback of the portion of image data (e.g., video and/or audio footage of the event). The summary of FIG. 4 is an example of a summary of a time period, such as a given day.

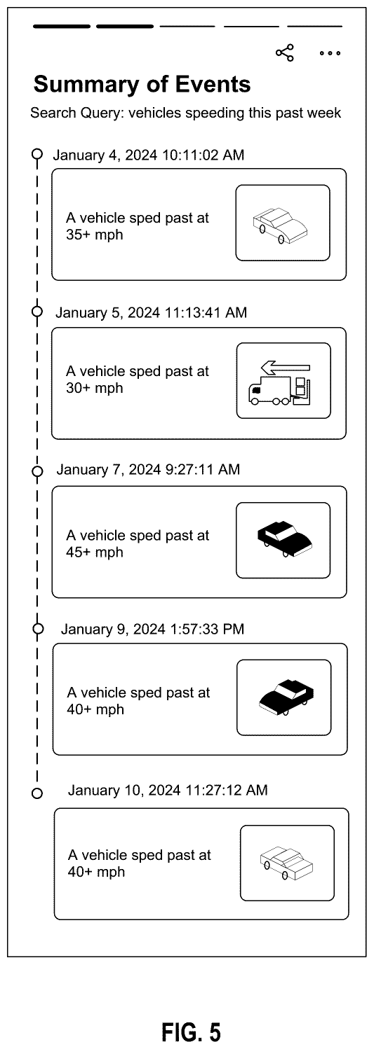

FIG. 5 is an example user interface presenting a summary of events, according to one embodiment of the present disclosure. The summary of events includes representation of multiple events with common or similar attributes or criteria. The user interface may enable entry of a search query including one or more search terms. For example, in FIG. 5 the search query is “vehicles speeding this week.” In some embodiments, a search query may be received and process using natural language processing. The search terms may be compared to tags associated with portions of image data and other sensor data to determine relevance to the query. Portions of image data and other sensor data having tags that match or otherwise correspond to the search terms of the search query may be presented. In FIG. 5, the portions of image data are presented according to chronological order. In other embodiments the portions of image data can be presented according to relevance, or other ordering. In FIG. 5, the portions of image data that match (e.g., tags that match) or are otherwise similar or relevant to the search query include clips captured of various vehicles (e.g., cars, trucks, bikes, etc.) traveling faster than the speed limit on the street of the premises. The summary presents a thumbnail representing each event. The thumbnail can be clicked/tapped to activate playback of the portion of image data (e.g., video and/or audio footage of the event). A single thumbnail may also represent multiple portions of image data, so as to collapse multiple clips of same thing(s)/event(s) into a singular representation/summary. In some embodiments, the summary can be configured by a user to provide representations, information, and/or formatting or an arrangement of information according to preferences or a configuration of a user.

In some embodiments, the user interface can invite user input to train/update/enhance a machine learning model.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. An apparatus comprising:
one or more sensor devices, including one or more image capture devices to capture image data of an environment;
one or more processors configured to execute instructions to perform operations to cause the apparatus to:
detect, using the one or more sensor devices, one or more entities within an environment;
determine, using sensor data captured by the one or more sensor devices, entity attributes of the one or more entities, the entity attributes of each entity including at least one of a distance attribute and a directionality attribute, the distance attribute indicating a distance from a region of interest within the environment and the directionality attribute indicating a direction of travel of the entity; and
generate, using the image data of the environment captured by the one or more image capture devices, tagged image data, the tagged image data including a set of tags each associated with a portion of the image data, the set of tags including one or more entity tags each indicating an entity attribute of the one or more entities appearing in the portion of the image data,
wherein the tagged image data is generated to be searchable on one or more designated tags of the set of tags to locate portions of the image data corresponding to the one or more designated tags.

2. The apparatus of claim 1, wherein the one or more processors are further configured to execute instructions to perform operations to cause the apparatus to:
receive a search query including one or more search terms;
locate within the tagged image data one or more relevant portions of the image data that correspond to the one or more designated tags as indicated by the one or more search terms; and
provide the one or more relevant portions of the image data for presentation to a user on a display device.

3. The apparatus of claim 1, wherein the one or more processors are further configured to execute instructions to perform operations to cause the apparatus to:
determine, using a machine learning model, an intent of an entity of the one or more entities, wherein the intent is an entity attribute of the entity.

4. The apparatus of claim 1, further comprising:
one or more microphones to capture audio data of the environment,
wherein the one or more processors are further configured to execute instructions to perform operations to cause the apparatus to:
determine, using the one or more microphones, one or more audio attributes of the image data; and
wherein the set of tags includes one or more audio tags each associated with a portion of the image data and indicating an audio attribute of the one or more audio attributes of the image data.

5. The apparatus of claim 1, wherein the set of tags include image tags corresponding to image capture attributes of the image data, including one or more of:
camera orientation data; and
time data.

6. The apparatus of claim 1, wherein the one or more processors are further configured to execute instructions to perform operations to cause the apparatus to:
determine, using the image data of the environment captured by the one or more image capture devices, an outcome associated with an entity of the one or more entities,
wherein the outcome is an entity attribute of the entity.

7. The apparatus of claim 1, wherein the one or more processors are further configured to execute instructions to perform operations to cause the apparatus to:
detect, using the one or more sensor devices, an event occurring within the environment;
determine, using sensor data captured by the one or more sensor devices, one or more event attributes of the event;
wherein the set of tags includes one or more event tags each associated with a portion of the image data and indicating an event attribute of the one or more event attributes of the image data.

8. The apparatus of claim 7, wherein the one or more sensor devices further includes a depth capture device.

9. The apparatus of claim 1, wherein the one or more processors are further configured to execute instructions to perform operations to cause the apparatus to:
provide, for presentation on a display device, a portion of the image data and one or more associated tags for the portion of image data;
receive user input providing one or more of:
confirmation of accuracy of one or more tags of the set of tags;
indication of inaccuracy of one or more tags of the set of tags; and
correction of one or more tags of the set of tags; and
update a machine learning model based on the user input.

10. A method comprising:
detecting, using one or more sensor devices, one or more entities within an environment;
determining, using sensor data captured by the one or more sensor devices, entity attributes of the one or more entities, the entity attributes of each entity including at least one of a distance attribute and a directionality attribute, the distance attribute indicating a distance from a region of interest within the environment and the directionality attribute indicating a direction of travel of the entity; and
generating, using image data from the sensor data of the environment captured by one or more image capture devices of the sensor devices, tagged image data, the tagged image data including a set of tags each associated with a portion of the image data, the set of tags including one or more entity tags each indicating an entity attribute of the one or more entities appearing in the portion of the image data,
wherein the tagged image data is generated to be searchable on one or more designated tags of the set of tags to locate portions of the image data corresponding to the one or more designated tags.

11. The method of claim 10, further comprising:
receiving a search query including one or more search terms;
locating within the tagged image data one or more relevant portions of the image data that correspond to the one or more designated tags as indicated by the one or more search terms;
providing the one or more relevant portions of the image data for presentation to a user on a display device.

12. The method of claim 10, further comprising:
determining, using a machine learning model, an intent of an entity of the one or more entities, wherein the intent is an entity attribute of the entity.

13. The method of claim 10, further comprising:
determining, using one or more microphones of the one or more sensor devices, one or more audio attributes of the image data,
wherein the set of tags includes one or more audio tags each associated with a portion of the image data and indicating an audio attribute of the one or more audio attributes of the image data.

14. The method of claim 10, wherein the set of tags include image tags corresponding to image capture attributes of the image data, including one or more of:
camera orientation data; and
time data.

15. The method of claim 10, further comprising:
determining, using the image data of the environment captured by the one or more image capture devices, an outcome associated with an entity of the one or more entities,
wherein the outcome is an entity attribute of the entity.

16. The method of claim 10, further comprising:
detecting, using the one or more sensor devices, an event occurring within the environment; and
determining, using sensor data captured by the one or more sensor devices, one or more event attributes of the event,
wherein the set of tags includes one or more event tags each associated with a portion of the image data and indicating an event attribute of the one or more event attributes of the image data.

17. The method of claim 16, wherein the one or more sensor devices further includes a depth capture device.

18. The method of claim 10, further comprising:
providing, for presentation on a display device, a portion of the image data and one or more associated tags for the portion of image data;
receiving user input providing one or more of:
confirmation of accuracy of one or more tags of the set of tags;
indication of inaccuracy of one or more tags of the set of tags; and
correction of one or more tags of the set of tags; and
updating a machine learning model based on the user input.

19. The method of claim 10, wherein the image data comprises video data.

20. An apparatus comprising:
one or more sensor devices, including one or more image capture devices to capture image data of an environment;
one or more processors configured to execute instructions to perform operations to cause the apparatus to:
detect, using the one or more sensor devices, one or more entities within an environment;
determine, using sensor data captured by the one or more sensor devices, entity attributes of the one or more entities, the entity attributes of each entity;
generate, using the image data of the environment captured by the one or more image capture devices, tagged image data, the tagged image data including a set of tags each associated with a portion of the image data, the set of tags including one or more entity tags each indicating an entity attribute of the one or more entities appearing in the portion of the image data;
receive a search query including one or more search terms;
locate within the tagged image data one or more relevant portions of the image data that correspond to one or more designated tags as indicated by the one or more search terms; and
provide the one or more relevant portions of the image data for presentation to a user on a display device.
